(19) United States
(12) Patent Application Publication
(10) Pub. No.: US 2026/0268833 A1
(43) Pub. Date: Sep. 10, 2026

(54) DISPLAY SYSTEM, METHOD FOR OPERATING THE SAME, AND ELECTRONIC DEVICE INCLUDING THE SAME

(71) Applicant: Samsung Display Co., Ltd., Yongin-si (KR)

(72) Inventors: Hyung Jin KIM, Yongin-si (KR); Min Kyu PARK, Yongin-si (KR); June Young LEE, Yongin-si (KR)

(21) Appl. No.: 19/348,501

(22) Filed: Oct. 2, 2025

(30) Foreign Application Priority Data
Mar. 6, 2025 (KR) 10-2025-0029262

(51) Int. Cl. G09G 3/32; G06F 3/01

(52) U.S. Cl. CPC G09G 3/32; G06F 3/013; G09G 2320/028; G09G 2320/0626; G09G 2320/068; G09G 2320/0693; G09G 2354/00; G09G 2380/10

(57) ABSTRACT

According to a method for operating a display system according to one or more embodiments of the present disclosure, the method includes moving a user using a moving device including a moving unit configured to support the user, determining a viewing angle of the user based on movement information of the moving unit, obtaining one of compensation parameters corresponding to the viewing angle from a memory of the display system, and generating compensation data for a display device based on the one of the compensation parameters.

### CROSS-REFERENCE TO RELATED APPLICATION

The present application claims priority to, and the benefit of, Korean Patent Application No. 10-2025-0029262, filed on Mar. 6, 2025, in the Korean Intellectual Property Office, the entire disclosure of which is incorporated herein by reference.

### BACKGROUND

### 1. Field

The present disclosure relates to a display system, a method for operating the same, and an electronic device including the same.

### 2. Description of the Related Art

With the development of information technology, the importance of a display device, which is a connection medium between a user and information, is being highlighted. Accordingly, the use of display devices, such as a liquid crystal display device and an organic light-emitting display device, is increasing.

A display device may include a display panel including pixels. Even if image data of the same color and brightness is output to the pixels of the display panel, an image outputting through the display panel may have irregular color deflection according to a viewing angle. Accordingly, it is desirable to compensate color deflection according to the angle at which the image is viewed.

The above-described content is only intended to help understand the background technology for the technical ideas of the present disclosure, and therefore, it cannot be understood as content corresponding to prior art known to those skilled in the art in the technical field of the present disclosure.

### SUMMARY

The display system, the method for operating the same, and the electronic device including the same according to one or more embodiments of the present disclosure displays images of relatively high quality. For example, the display system can perform adaptively compensate image data for a viewing angle of the user and/or position, and can display an image according to a compensated image data.

In a method for operating a display system according to one or more embodiments of the present disclosure, the method includes moving a user using a moving device including a moving unit configured to support the user, determining a viewing angle of the user based on movement information of the moving unit, obtaining one of compensation parameters corresponding to the viewing angle from a memory of the display system, and generating compensation data for a display device based on the one of the compensation parameters.

The movement information may indicate a distance of the moving unit from a reference position, wherein the reference position is a first distance from a center point of the display device in a first direction, and is a second distance from the center point in a second direction that is different from the first direction, and wherein the viewing angle is based on a ratio of the second distance to the first distance when the moving unit corresponds to the reference position.

The viewing angle may be based on a ratio of the second distance to a sum of the first distance and a first movement distance by which the moving device moves the user from the reference position in the first direction.

The viewing angle may be based on a ratio of a sum of the second distance and a second movement distance to the sum of the first distance and the first movement distance when the moving device moves the user from the reference position by the second movement distance in the second direction.

The moving unit may include a first moving unit and a second moving unit that are configured to be independently driven, wherein, when the first moving unit is configured to move the user from the reference position by the first movement distance and the second movement distance, and when the second moving unit is configured to move the user by a 1_1st movement distance in the first direction from the reference position, the viewing angle is based on a ratio of the sum of the second distance and the second movement distance to a sum of the first distance, the first movement distance, and the 1_1st movement distance.

The determining the viewing angle may include capturing an image of an eye of the user, generating visual sensing data based on the image, and determining the viewing angle based on the visual sensing data.

The method may further include outputting an image through the display device based on the compensation data, receiving sub-viewing angle data regarding a changed viewing angle that is different from the viewing angle, determining a second one of the compensation parameters corresponding to the changed viewing angle, and generating second compensation data based on the second one of the compensation parameters.

The generating the second compensation data may include storing a position of the moving unit corresponding to the changed viewing angle in a storage medium of the moving device.

A display system according to one or more embodiments of the present disclosure includes a display device for outputting an image based on compensation data, a moving device including a moving unit configured to support a user of the display device and to move the user, and a compensating device configured to provide the compensation data to the display device, and including a memory configured to store compensation parameters respectively corresponding to viewing angles, and a compensation data generator configured to determine a viewing angle of the user based on movement information of the moving unit, to obtain one of the compensation parameters corresponding to the viewing angle from the memory, and to generate the compensation data based on the one of the compensation parameters.

The movement information may indicate a distance of the moving unit from a reference position that is a first distance from a center point of the display device in a first direction, and that is a second distance from the center point in a second direction different from the first direction, wherein the compensation data generator is configured to calculate the viewing angle based on a ratio of the second distance to the first distance.

When the moving device moves the user from the reference position in the first direction by a first movement distance, the compensation data generator may be configured to calculate the viewing angle based on a ratio of the second distance to a sum of the first distance and the first movement distance.

When the moving device moves the user from the reference position in the second direction by a second movement distance, the compensation data generator may be configured to calculate the viewing angle based on a ratio of a sum of the second distance and the second movement distance to the sum of the first distance and the first movement distance.

The moving unit may include a first moving unit and a second moving unit, which are configured to be independently driven, wherein, when the first moving unit moves the user from the reference position by the first movement distance and the second movement distance, and the second moving unit moves the user by a 1_1st movement distance in the first direction from the reference position, the compensation data generator is configured to calculate the viewing angle based on a ratio of the sum of the second distance and the second movement distance to a sum of the first distance, the first movement distance, and the 1_1st movement distance.

The display device may include a camera configured to capture an image of an eye of the user, wherein the compensating device is configured to generate visual sensing data based on the image, and to determine the viewing angle based on the visual sensing data.

The display device may be implemented as a vehicle display device.

In an electronic device according to one or more embodiments of the present disclosure, the electronic device includes a processor, a display device configured to display an image according to a control of the processor, and a moving device including a moving unit configured to support a user of the display device and to move the user, wherein the processor includes a memory configured to store compensation parameters respectively corresponding to viewing angles, is configured to determine a viewing angle of the user based on movement information of the moving unit, is configured to obtain one of the compensation parameters corresponding to the viewing angle from the memory, is configured to generate compensation data based on the one of the compensation parameters, and is configured to provide the generated compensation data to the display device.

The movement information may indicate a distance of the moving unit from a reference position, wherein the reference position is a first distance from a center point of the display device in a first direction, and is a second distance from the center point in a second direction that is different from the first direction, and wherein the viewing angle is based on a ratio of the second distance to the first distance when the moving unit corresponds to the reference position.

The viewing angle may be based on a ratio of the second distance to a sum of the first distance and a first movement distance by which the moving device moves the user from the reference position in the first direction.

The processor may be configured to determine the viewing angle by capturing an image of an eye of the user, generating visual sensing data based on the image, and determining the viewing angle based on the visual sensing data.

The processor may be further configured to output the image through the display device based on the compensation data, receive sub-viewing angle data regarding a changed viewing angle that is different from the viewing angle, determine a second one of the compensation parameters corresponding to the changed viewing angle, and generate second compensation data based on the second one of the compensation parameters.

According to embodiments of the present disclosure, the display system, the method for operating the same, and the electronic device including the same may display an image of relatively high quality.

The aspects in the embodiments are not limited to those illustrated above, and more varied aspects are included within this specification.

### BRIEF DESCRIPTION OF THE DRAWINGS

FIG. 1 is a block diagram illustrating one or more embodiments of a display system.

FIG. 2 is a block diagram illustrating one or more embodiments of one of sub-pixels of FIG. 1.

FIG. 3 is a block diagram illustrating one or more embodiments of a parameter generation device.

FIG. 4 is a flowchart illustrating an operation of the parameter generation device of FIG. 3.

FIGS. 5 to 7 are drawings illustrating how the parameter generation device captures an image represented by a display device at multiple viewpoints.

FIG. 8 is a block diagram illustrating one or more embodiments of a compensating device of FIG. 1.

FIG. 9 is a diagram illustrating one or more embodiments of a lookup table in FIG. 8.

FIG. 10 is a block diagram illustrating one or more embodiments of a moving device of FIG. 1.

FIG. 11 is a flowchart illustrating an operation of the display system in FIG. 8.

FIGS. 12 to 15 are drawings illustrating a driving method of the moving device of FIG. 10.

FIG. 16 is a block diagram illustrating one or more embodiments of the display system.

FIG. 17 is a flowchart illustrating one or more embodiments of operation S1120 of FIG. 11.

FIG. 18 is a block diagram illustrating one or more embodiments of the display system.

FIG. 19 is a flowchart illustrating a compensation method for the display device according to one or more embodiments of the present disclosure.

FIG. 20 is a block diagram illustrating an electronic device according to one or more embodiments.

FIG. 21 illustrates schematic diagrams of electronic devices according to various embodiments.

### DETAILED DESCRIPTION

Aspects of some embodiments of the present disclosure and methods of accomplishing the same may be understood more readily by reference to the detailed description of embodiments and the accompanying drawings. The described embodiments are provided as examples so that this disclosure will be thorough and complete, and will fully convey the aspects of the present disclosure to those skilled in the art. Accordingly, processes, elements, and techniques that are redundant, that are unrelated or irrelevant to the description of the embodiments, or that are not necessary to those having ordinary skill in the art for a complete understanding of the aspects of the present disclosure may be omitted. Unless otherwise noted, like reference numerals, characters, or combinations thereof denote like elements throughout the attached drawings and the written description, and thus, repeated descriptions thereof may be omitted.

The described embodiments may have various modifications and may be embodied in different forms, and should not be construed as being limited to only the illustrated embodiments herein. The use of “can,” “may,” or “may not” in describing an embodiment corresponds to one or more embodiments of the present disclosure.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

In the drawings, the relative sizes of elements, layers, and regions may be exaggerated for clarity and/or descriptive purposes. In other words, because the sizes and thicknesses of elements in the drawings are arbitrarily illustrated for convenience of description, the disclosure is not limited thereto.

Spatially relative terms, such as “beneath,” “below,” “lower,” “lower side,” “under,” “above,” “upper,” “over,” “higher,” “upper side,” “side” (e.g., as in “sidewall”), and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below,” “beneath,” “or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly. Similarly, when a first part is described as being arranged “on” a second part, this indicates that the first part is arranged at an upper side or a lower side of the second part without the limitation to the upper side thereof on the basis of the gravity direction.

It will be understood that when an element, layer, region, or component (e.g., an apparatus, a device, a circuit, a wire, an electrode, a terminal, a conductive film, etc.) is referred to as being “formed on,” “on,” “connected to,” or “(operatively, functionally, or communicatively) coupled to” another element, layer, region, or component, it can be directly formed on, on, connected to, or coupled to the other element, layer, region, or component, or indirectly formed on, on, connected to, or coupled to the other element, layer, region, or component such that one or more intervening elements, layers, regions, or components may be present. In addition, this may collectively mean a direct or indirect coupling or connection and an integral or non-integral coupling or connection.

For example, when a layer, region, or component is referred to as being “electrically connected” or “electrically coupled” to another layer, region, or component, it can be directly electrically connected or coupled to the other layer, region, and/or component or one or more intervening layers, regions, or components may be present. The one or more intervening components may include a switch, a transistor, a resistor, an inductor, a capacitor, a diode and/or the like. Accordingly, a connection is not limited to the connections illustrated in the drawings or the detailed description and may also include other types of connections. In describing embodiments, an expression of connection indicates electrical connection unless explicitly described to be direct connection, and “directly connected/directly coupled,” or “directly on,” refers to one component directly connecting or coupling another component, or being on another component, without an intermediate component.

Meanwhile, other expressions describing relationships between components, such as “between,” “immediately between” or “adjacent to” and “directly adjacent to,” may be construed similarly. It will be understood that when an element or layer is referred to as being “between” two elements or layers, it can be the only element or layer between the two elements or layers, or one or more intervening elements or layers may also be present.

For the purposes of this disclosure, expressions such as “at least one of,” or “any one of,” or “one or more of” when preceding a list of elements, modify the entire list of elements and do not modify the individual elements of the list. For example, “at least one of X, Y, and Z,” “at least one of X, Y, or Z,” “at least one selected from the group consisting of X, Y, and Z,” and “at least one selected from the group consisting of X, Y, or Z” may be construed as X only, Y only, Z only, any combination of two or more of X, Y, and Z, such as, for instance, XYZ, XY, YZ, and XZ, or any variation thereof. Similarly, the expressions “at least one of A and B” and “at least one of A or B” may include A, B, or A and B. As used herein, “or” generally means “and/or,” and the term “and/or” includes any and all combinations of one or more of the associated listed items. For example, the expression “A and/or B” may include A, B, or A and B. Similarly, expressions such as “at least one of,” “a plurality of,” “one of,” and other prepositional phrases, when preceding a list of elements, modify the entire list of elements and do not modify the individual elements of the list. When “C to D” is stated, it means C or more and D or less, unless otherwise specified.

It will be understood that, although the terms “first,” “second,” “third,” etc., may be used herein to describe various elements, components, regions, layers and/or sections, these elements, components, regions, layers and/or sections should not be limited by these terms. These terms do not correspond to a particular order, position, or superiority, and are only used to distinguish one element, member, component, region, area, layer, section, or portion from another element, member, component, region, area, layer, section, or portion. Thus, a first element, component, region, layer, or section described below could be termed a second element, component, region, layer, or section, without departing from the spirit and scope of the present disclosure. The description of an element as a “first” element may not require or imply the presence of a second element or other elements. The terms “first,” “second,” etc. may also be used herein to differentiate different categories or sets of elements. For conciseness, the terms “first,” “second,” etc. may represent “first-category (or first-set),” “second-category (or second-set),” etc., respectively.

In the examples, the x-axis, the y-axis, and/or the z-axis are not limited to three axes of a rectangular coordinate system, and may be interpreted in a broader sense. For example, the x-axis, the y-axis, and the z-axis may be perpendicular to one another, or may represent different directions that are not perpendicular to one another. The same applies for first, second, and/or third directions.

The terminology used herein is for the purpose of describing embodiments only and is not intended to be limiting of the present disclosure. As used herein, the singular forms “a” and “an” are intended to include the plural forms as well, while the plural forms are also intended to include the singular forms, unless the context clearly indicates otherwise. It will be further understood that the terms “comprises,” “comprising,” “have,” “having,” “includes,” and “including,” when used in this specification, specify the presence of the stated features, integers, steps, operations, elements, and/or components, but do not preclude the presence or addition of one or more other features, integers, steps, operations, elements, components, and/or groups thereof.

When one or more embodiments may be implemented differently, a specific process order may be performed differently from the described order. For example, two consecutively described processes may be performed substantially at the same time or performed in an order opposite to the described order.

As used herein, the terms “substantially,” “about,” “approximately,” and similar terms are used as terms of approximation and not as terms of degree, and are intended to account for the inherent deviations in measured or calculated values that would be recognized by those of ordinary skill in the art. For example, “substantially” may include a range of +/−5% of a corresponding value. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within +30%, 20%, 10%, 5% of the stated value. Further, the use of “may” when describing embodiments of the present disclosure refers to “one or more embodiments of the present disclosure.” Furthermore, the expression “being the same” may mean “being substantially the same.” In other words, the expression “being the same” may include a range that can be tolerated by those of ordinary skill in the art. The other expressions may also be expressions from which “substantially” has been omitted.

In some embodiments well-known structures and devices may be described in the accompanying drawings in relation to one or more functional blocks (e.g., block diagrams), units, and/or modules to avoid unnecessarily obscuring various embodiments. Those skilled in the art will understand that such block, unit, and/or module are/is physically implemented by a logic circuit, an individual component, a microprocessor, a hard wire circuit, a memory element, a line connection, and other electronic circuits. This may be formed using a semiconductor-based manufacturing technique or other manufacturing techniques. The block, unit, and/or module implemented by a microprocessor or other similar hardware may be programmed and controlled using software to perform various functions discussed herein, optionally may be driven by firmware and/or software. In addition, each block, unit, and/or module may be implemented by dedicated hardware, or a combination of dedicated hardware that performs some functions and a processor (for example, one or more programmed microprocessors and related circuits) that performs a function different from those of the dedicated hardware. In addition, in some embodiments, the block, unit, and/or module may be physically separated into two or more interact individual blocks, units, and/or modules without departing from the scope of the present disclosure. In addition, in some embodiments, the block, unit and/or module may be physically combined into more complex blocks, units, and/or modules without departing from the scope of the present disclosure.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

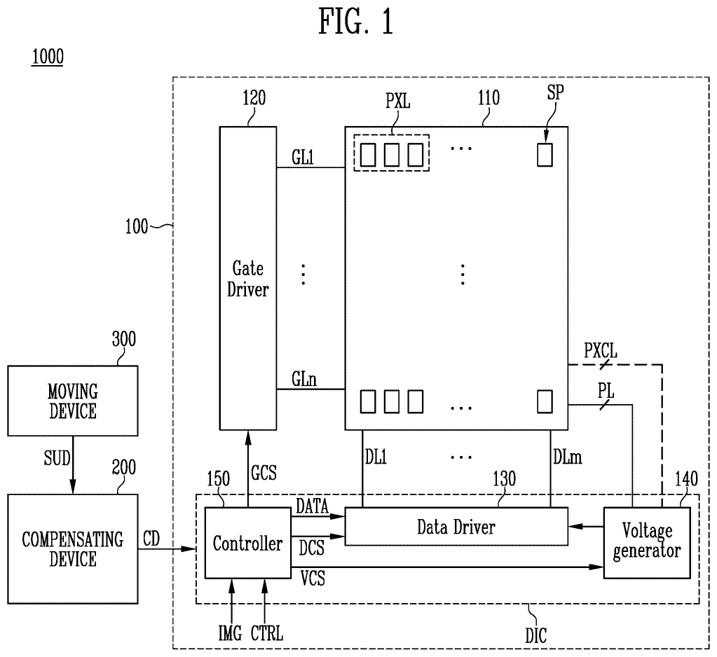

FIG. 1 is a block diagram illustrating one or more embodiments of a display system.

In FIG. 1, the display system 1000 may include a display device 100, a compensating device 200, and a moving device 300.

The display device 100 may include a display panel 110, a gate driver 120, a data driver 130, a voltage generator 140, and a controller 150.

The display panel 110 includes sub-pixels SP. The sub-pixels SP may be connected to the gate driver 120 via the first to m-th gate lines GL1 to GLm. The sub-pixels SP may be connected to the data driver 130 via the first to the n-th data lines DL1 to DLn.

According to one or more embodiments, the display panel 110 may operate in multiple operating modes. For example, the display panel 110 may be operated in normal mode, which outputs an image that is recognized equally from any angle. In addition, the display panel 110 may be operated in a private mode, which outputs an image that is not recognized at a corresponding angle, or that is recognized at another corresponding angle. However, this is merely illustrative and is not limited thereto.

The sub-pixels SP may emit light of two or more colors. Each of the sub-pixels SP may emit light of red, green, blue, cyan, magenta, and/or yellow, etc.

Two or more sub-pixels among the sub-pixels SP may form one pixel PXL. For example, a pixel PXL may include three sub-pixels as shown in FIG. 1. In this way, the pixel PXL may emit light of different colors and brightnesses according to combination of the light emitted by the sub-pixels included therein.

The gate driver 120 is connected to the sub-pixels SP arranged in a row direction through the first to m-th gate lines GL1 to GLm. The gate driver 120 may output scan signals to the first to m-th gate lines GL1 to GLm in response to a gate control signals GCS. In embodiments, the gate control signal GCS may include a scan start signal FLM (see FIG. 3) and a clock signal CLK (see FIG. 3).

The gate driver 120 may be located on one side of the display panel 110. However, embodiments are not limited to thereto. For example, the gate driver 120 may be divided into two or more physically and/or logically separated drivers, and such drivers may be placed on one side of the display panel 110 and on another side of a display panel 110 opposite the one side. In this way, the gate driver 120 may be located around the display panel 110 in various forms according to the embodiments.

The data driver 130 is connected to the sub-pixels SP arranged in a column direction via the first to the n-th data lines DL1 to DLn. The data driver 130 receives image data DATA and a data control signal DCS from the controller 150. The data driver 130 may operate in response to the data control signal DCS. In embodiments, the data control signal DCS may include a source start signal, a source shift clock, and a source output enable signal.

The data driver 130 may receive voltages from the voltage generator 140. Using the received voltages, the data driver 130 may provide data signals having grayscale voltages corresponding to the image data DATA to the first or n-th data lines DL1 to DLn. When a scan signal is provided to the first to m-th gate lines GL1 to GLm, the data signals corresponding to the image data DATA may be provided to the data lines DL1 to DLn. Accordingly, the sub-pixels SP may generate light corresponding to the data signals, and the display panel 110 may display an image.

In embodiments, the gate driver 120 and the data driver 130 may include complementary metal-oxide semiconductor (CMOS) circuit elements.

The voltage generator 140 may operate in response to a voltage control signal VCS from the controller 150. The voltage generator 140 is configured to generate a plurality of voltages and to supply the generated voltages to components of the display device 100, such as the gate driver 120, data driver 130, and the controller 150. The voltage generator 140 may generate a plurality of voltages by receiving input voltage from the outside of the display device 100 and by regulating the received voltage.

The voltage generator 140 may generate a first power voltage and a second power voltage. The generated first and second power voltages may be supplied to the sub-pixels SP through power lines PL.

In one or more embodiments, at least one of the first and/or second power voltages may be supplied from outside the display device 100.

Furthermore, the voltage generator 140 may provide various voltages and/or signals. For example, the voltage generator 140 may provide one or more initialization voltages provided in the sub-pixels SP. For example, in a sensing operation for sensing electrical characteristics of transistors and/or light-emitting elements of sub-pixels SP, a set reference voltage may be provided to the first to n-th data lines DL1 to DLn, and the voltage generator 140 may generate and transmit the reference voltage to the data driver 130. For example, during a display operation to display an image on the display panel 110, common pixel control signals may be provided to the sub-pixels SP, and the voltage generator 140 may generate the pixel control signals. In one or more embodiments, the voltage generator 140 may provide the pixel control signals to the sub-pixels SP through pixel control lines PXCL. In FIG. 1, the pixel control lines PXCL are shown to be connected between the voltage generator 140 and the display panel 110, but embodiments are not limited thereto. For example, the pixel control lines PXCL may be connected between the gate driver 120 and the display panel 110. In this case, the pixel control signals may be transmitted from the voltage generator 140 to the pixel control lines PXCL via the gate driver 120.

The controller 150 controls all operations of the display device 100. The controller 150 receives input image data IMG and a control signal CTRL corresponding thereto from the outside. In response to the control signal CTRL, the controller 150 may provide the gate control signal GCS, the data control signal DCS, and the voltage control signal VCS.

The controller 150 may output the image data DATA by converting the input image data IMG to be suitable for the display device 100 or the display panel 110. In embodiments, the controller 150 may output the image data DATA by arranging the input image data IMG to be suitable for the sub-pixels SP in a row unit. The controller 150 may compensate the input image data IMG according to compensation data (CD), and may generate the image data DATA based on the calibrated image data. The controller 150 may compensate the input image data IMG according to compensation data CD based on at least one of various algorithms or methods known in the art.

Two or more components among the data driver 130, the voltage generator 140, and the controller 150 may be embedded in one integrated circuit. As shown in FIG. 1, the data driver 130, the voltage generator 140, and the controller 150 may be included in a driver integrated circuit DIC. In this case, the data driver 130, the voltage generator 140, and the controller 150 may be functionally separate components within a single driver integrated circuit DIC. In one or more embodiments, at least one of the data driver 130, voltage generator 140, or controller 150 may be provided as a separate component from the driver integrated circuit DIC.

The compensating device 200 may provide the compensation data CD to the display device 100. For example, the compensating device 200 may generate the compensation data CD, which is used to compensating brightness of an image represented by the display device 100 at a plurality of viewpoints.

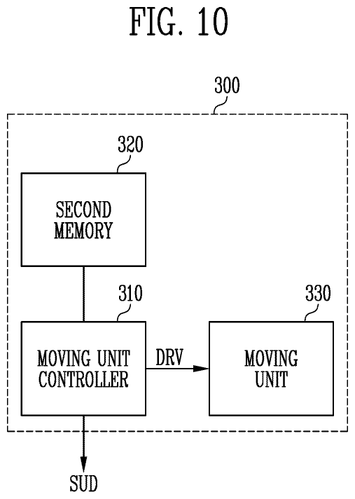

The moving device 300 may be configured to move the user of the display device 100. For example, the moving device 300 may move the user by moving a moving unit 330 (see FIG. 10) supporting the user of the display device 100. In addition, the moving device 300 may provide the compensating device 200 with movement data SUD corresponding to movement information of the moving unit 330.

In a comparative example, the user may recognize irregular color deflection in the image according to an angle from which the display device 100 or display panel 110 is viewed. In one or more embodiments of the present disclosure, the display device 100 may improve the quality of the image recognized by the viewers by generating the image data DATA by compensating the input image data IMG by considering a viewing angle according to a distance moved by the user by the moving device 300.

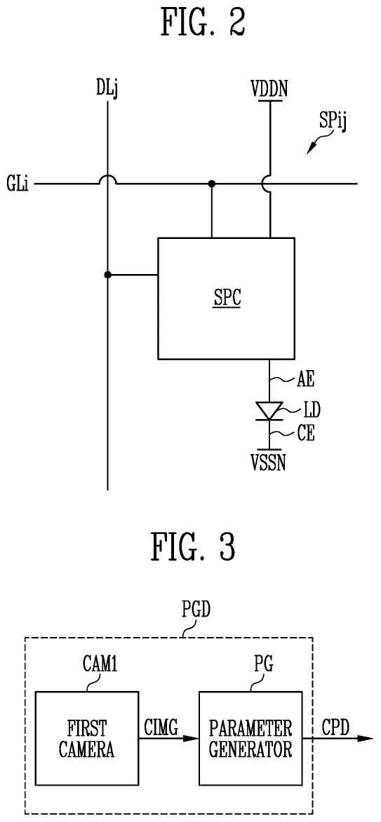

FIG. 2 is a block diagram illustrating one or more embodiments of one of sub-pixels of FIG. 1. In FIG. 2, a sub-pixel SPij arranged in a i-th row (where i is an integer equal to or greater than 1 and equal to or smaller than m) and a j-th column (where j is an integer equal to or greater than 1 and equal to or smaller than n) of the sub-pixels SP of FIG. 1 is illustrated.

Referring to FIG. 2, the sub-pixel SPij may include a sub-pixel circuit SPC and a light-emitting element LD.

The light-emitting element LD is connected between a first power voltage node VDDN and a second power voltage node VSSN. The first power voltage node VDDN is connected to one of the power lines PL of FIG. 1, and receives a first power voltage. The second power voltage node VSSN is connected to another one of the power lines PL in FIG. 1, and receives a second power voltage. The first power voltage may have a higher voltage level than the second power voltage.

The light-emitting element LD is connected between an anode electrode AE and a cathode electrode CE. The anode electrode AE may be connected to the first power voltage node VDDN via the sub-pixel circuit SPC. For example, the anode electrode AE may be connected to the first power voltage node VDDN via one or more transistors included in the sub-pixel circuit SPC. The cathode electrode CE may be connected to the second power voltage node VSSN. The light-emitting element LD is configured to emit light according to a current flowing from the anode electrode AE to the cathode electrode CE.

The sub-pixel circuit SPC may be connected to i-th gate line GLi among the first to m-th gate lines GL1 to GLm of FIG. 1, and to a j-th data line DLj among the first to n-th data lines DL1 to DLn of FIG. 1. In response to a scan signal received through the i-th gate line GLi, the sub-pixel circuit SPC controls the light-emitting element LD to emit light according to a data signal received through the j-th data line DLj. In embodiments, the sub-pixel circuit SPC may be further connected to the pixel control lines PXCL of FIG. 1. In this case, the sub-pixel circuit SPC may control the light-emitting element LD more responsively than pixel control signals received through the pixel control lines PXCL.

For these operations, the sub-pixel circuits SPC may include circuit components, for example transistors and one or more capacitors.

The transistors in the sub-pixel circuit SPC may include n-type transistors and/or p-type transistors. In embodiments, the transistors in the sub-pixel circuit SPC may include a Metal Oxide Silicon Field Effect Transistor (MOSFET). In embodiments, the transistors in the sub-pixel circuit SPC may include an amorphous silicon semiconductor, a monocrystalline silicon semiconductor, a polycrystalline silicon semiconductor, an oxide semiconductor, etc.

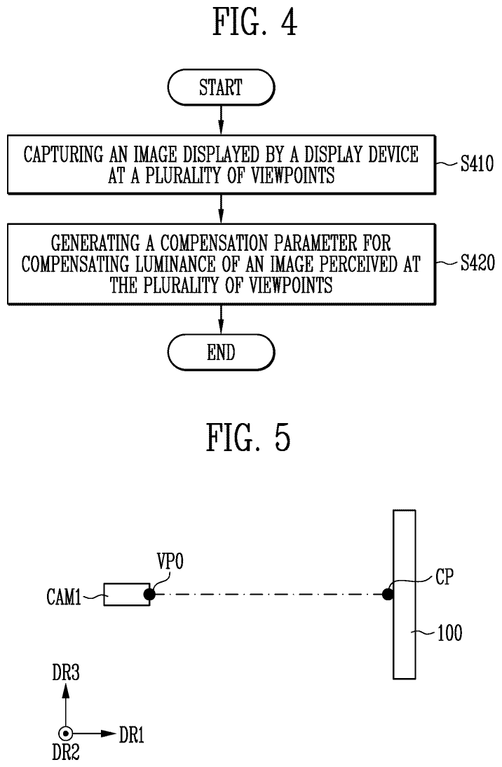

FIG. 3 is a block diagram illustrating one or more embodiments of a parameter generation device. FIG. 4 is a flowchart illustrating an operation of the parameter generation device of FIG. 3. FIGS. 5 to 7 are drawings illustrating how the parameter generation device captures an image represented by a display device at multiple viewpoints.

Referring to FIG. 3, a parameter generating device PGD may include a first camera CAM1 and a parameter generator PG.

The first camera CAM1 may capture an image represented by the display device 100 (see FIG. 1). The first camera CAM1 may include an image sensor. According to one or more embodiments, the first camera CAM1 may be a CCD (charge-coupled device) camera. However, this is merely illustrative and is not limited thereto.

The parameter generator PG may generate a compensation parameter CPD, which is used for compensating brightness of an image of the display device 100, based on image data CIMG respectively captured at multiple viewpoints.

According to one or more embodiments, a parameter generating device PGD may be configured to provide compensation parameters CPD to the compensating device 200 in a manufacturing process of the display system 1000. For example, the compensating device 200 may receive the compensation parameters CPD from the parameter generating device PGD during a manufacturing process. The parameter generating device PGD may be a separate configuration not included in the display system (see FIG. 1) that is driven.

According to FIG. 4, a method of operating the parameter generation device according to one or more embodiments of the present disclosure, may include operations S410 and S420.

In this specification, although operations are described as being performed sequentially according to a flowchart, it is apparent that, unless the spirit of the disclosure is altered, some operations depicted as being performed consecutively may be performed concurrently or substantially simultaneously, the order of the operations may be changed, some operations may be omitted, or additional operations may be inserted between the operations.

Referring to FIGS. 4 and 5, in operation S410, the first camera CAM1 may capture an image displayed by the display device 100 at each of a plurality of viewpoints. For example, the first camera CAM1 may capture an image displayed by the display device 100 at a zeroth viewpoint VP0.

Referring to FIGS. 4 to 6, in operation S410, the first camera CAM1 may capture an image displayed by the display device 100 at a first viewpoint VP1. For example, the first camera CAM1 may capture an image displayed by the display device 100 at the first viewpoint VP1, which is a distance from the zeroth viewpoint VP0 in a third direction DR3. The first camera CAM1 may capture the display device 100 at the first viewpoint VP1 with a first viewing angle AG1. For example, the first viewing angle AG1 may be an angle rotated toward a central region CP from the first viewpoint VP1 with reference to a first direction DR1.

The central region CP may correspond to a central portion of a surface of the display device 100 from which an image is output in a direction opposite to the first direction DR1. However, this is merely illustrative and is not limited thereto.

Referring to FIGS. 4 to 7, in the operation S410, the first camera CAM1 may capture an image displayed by the display device 100 at a second viewpoint VP2. For example, the first camera CAM1 may capture an image displayed by the display device 100 at the second viewpoint VP2, which may be a distance from the first viewpoint VP1 in a third direction DR3. The first camera CAM1 may capture the display device 100 at the second viewpoint VP2 with a second viewing angle AG2. For example, the second viewing angle AG2 may be an angle rotated toward the central region CP from the second viewpoint VP2 with reference to the first direction DR1. According to one or more embodiments, the second viewing angle AG2 may be greater than the first viewing angle AG1.

The first camera CAM1 may generate image data CIMG based on the images captured of the display device 100. The image data CIMG may include information regarding the images displayed by the display device 100 at each of the plurality of viewpoints.

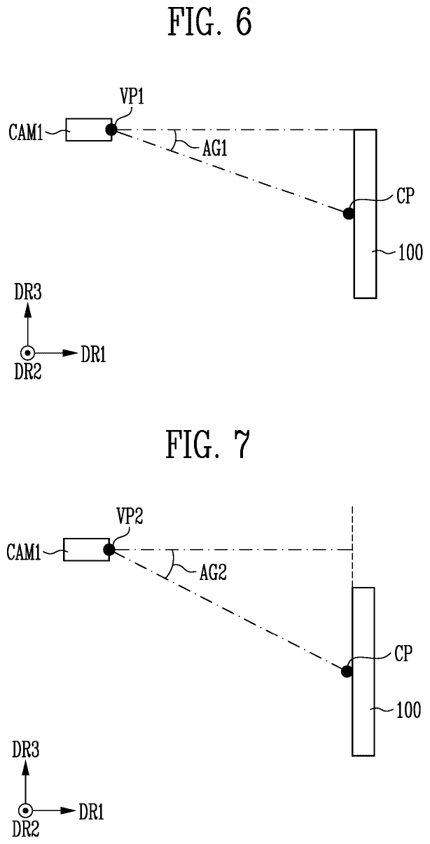

Referring again to FIGS. 3 and 4, in operation S420, the parameter generator PG may generate a compensation parameter CPD (e.g., to compensate luminance of an image perceived at the viewpoints). For example, when a user of the display device 100 views an image at the first viewpoint VP1 (see FIG. 6), a color deflection pattern may be visible in the image. The parameter generator PG may identify the color deflection pattern of the image visible at the first viewpoint VP1 based on the image data CIMG. The parameter generator PG may generate the compensation parameter to correct the identified color deflection pattern. Similarly, the parameter generator PG may generate the compensation parameter to compensate a color deflection pattern based on the image data CIMG captured at the zeroth viewpoint VP0 and the second viewpoint VP2, respectively.

In embodiments, the compensation parameters CPD may represent values related to the luminance information of light emitted by the sub-pixel SP (see FIG. 1) of the display device 100. For example, the compensation parameter CPD may include offset values or gamma correction values for adjusting the luminance of the light emitted by the sub-pixel SP. However, this is merely illustrative and is not limited thereto.

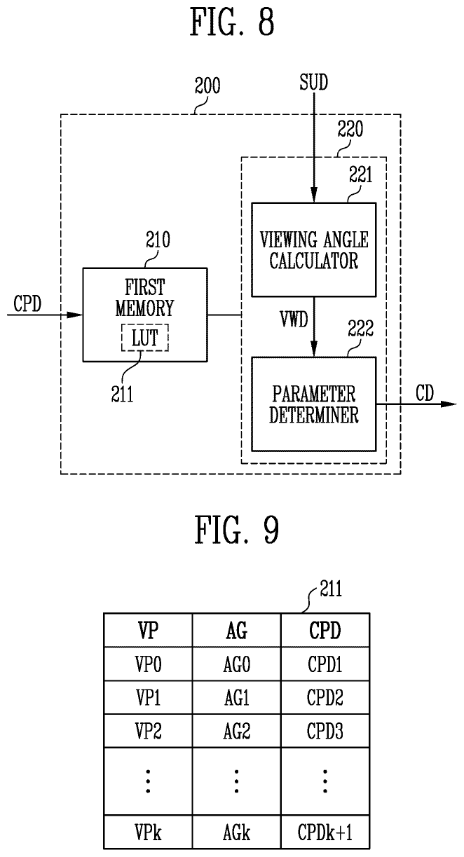

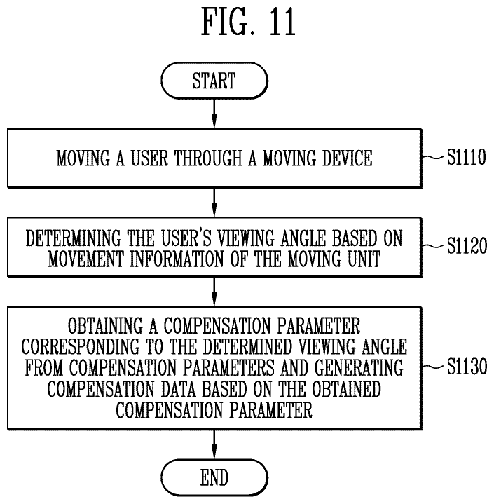

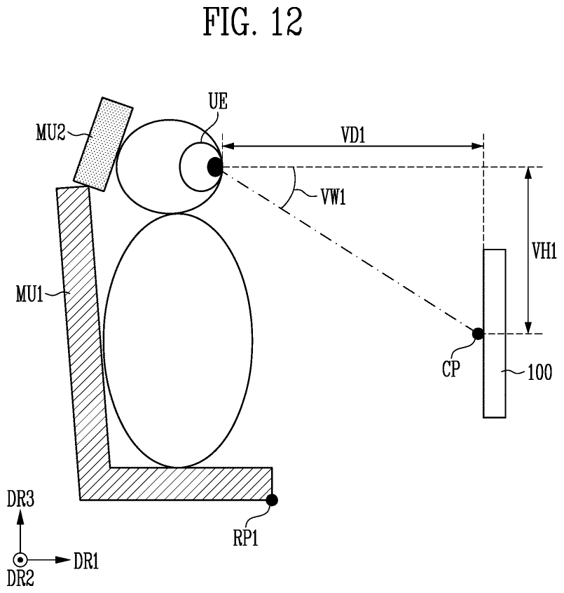

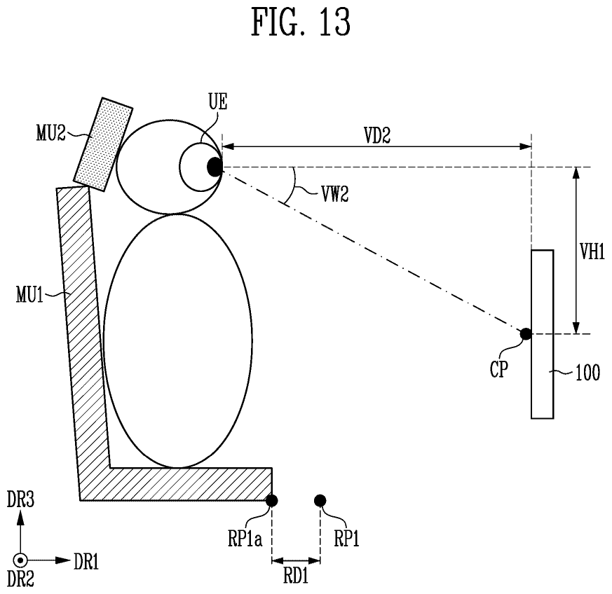

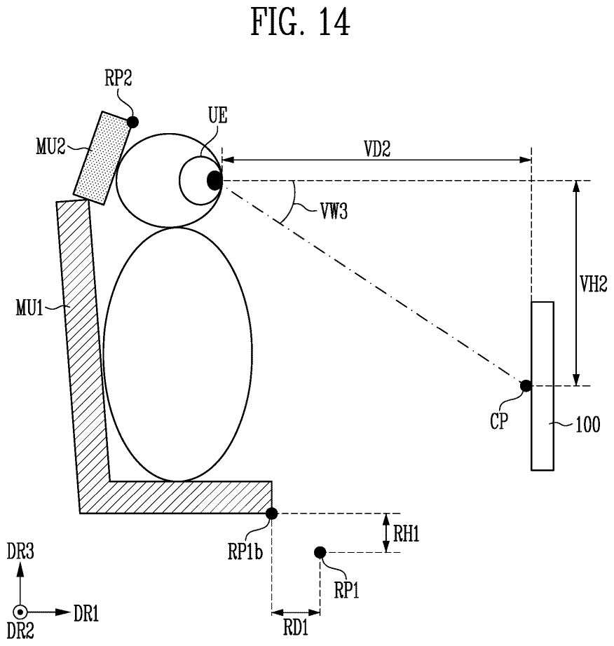

FIG. 8 is a block diagram illustrating one or more embodiments of a compensating device of FIG. 1. FIG. 9 is a diagram illustrating one or more embodiments of a lookup table in FIG. 8. FIG. 10 is a block diagram illustrating one or more embodiments of a moving device of FIG. 1. FIG. 11 is a flowchart illustrating an operation of the display system in FIG. 8. FIGS. 12 to 15 are drawings illustrating a driving method of the moving device of FIG. 10.

Referring to FIG. 8, the compensating device 200 may include a first memory 210 and a compensation data generator 220.

The first memory 210 may store the compensation parameter CPD. For example, the first memory 210 may receive the compensation parameter CPD from the parameter generation device PGD (see FIG. 3).

Referring to FIGS. 8 and 9, the first memory 210 may store the compensation parameter CPD in the form of a lookup table 211. The lookup table 211 may include an observation angle AG and the compensation parameter CPD corresponding to each of a plurality of viewpoints VP.

A zeroth observation angle AG0 and a first compensation parameter CPD1 may correspond to a zeroth viewpoint VP0. For example, an angle for observing an image displayed by the display device 100 at the zeroth viewpoint VP0 may be the zeroth observation angle AG0. The compensation parameter CPD for compensating luminance of the image displayed by the display device 100 at the zeroth viewpoint VP0 may be the first compensation parameter CPD1. In embodiments, the zeroth observation angle AG0 may be 0 degrees.

A first observation angle AG1 and a second compensation parameter CPD2 may correspond to a first viewpoint VP1. An angle for observing the image displayed by the display device 100 at the first viewpoint VP1 may be the first observation angle AG1. The compensation parameter CPD for compensating luminance of the image displayed by the display device 100 at the first viewpoint VP1 may be the second compensation parameter CPD2.

A second observation angle AG2 and a third compensation parameter CPD3 may correspond to a second viewpoint VP2. An angle for observing the image displayed by the display device 100 at the second viewpoint VP2 may be the second observation angle AG2. The compensation parameter CPD for compensating luminance of the image displayed by the display device 100 at the second viewpoint VP2 may be the third compensation parameter CPD3.

A k-th observation angle AGk (where k is an integer equal to or greater than 0) and a (k+1)-th compensation parameter CPDk+1 may correspond to a k-th viewpoint VPk. An angle for observing the image displayed by the display device 100 at the k-th viewpoint VPk may be the k-th observation angle AGk. The compensation parameter CPD for compensating the luminance of the image displayed by the display device 100 at the k-th viewpoint may be the (k+1)-th compensation parameter (CPDk+1).

Referring again to FIG. 8, the compensation data generator 220 may include a viewing angle calculator 221 and a parameter determiner 222.

The viewing angle calculator 221 may receive movement data SUD from the moving device 300 (see FIG. 1). The viewing angle calculator 221 may calculate the user's viewing angles for the display device 100 based on the movement data SUD.

The parameter determiner 222 may receive viewing angle data VWD from the viewing angle calculator 221. The viewing angle data VWD may include information regarding viewing angles corresponding to positions for observing the image displayed by the display device 100.

The parameter determiner 222 may generate compensation data CD based on the viewing angle data VWD. The parameter determiner 222 may provide the generated compensation data CD to the display device 100.

Referring to FIG. 10, the moving device 300 may include a moving unit controller 310, a second memory 320, and a moving unit 330.

The moving unit controller 310 may control the moving unit 330 to move through a drive signal DRV. For example, the moving unit 330 may support at least a portion of the user's body for the display device 100 (see FIG. 12). The user of the display device 100 may cause the moving unit controller 310 to generate and transmit the drive signal DRV to the moving unit 330, and the moving unit 330 may be controlled based on the drive signal DRV. Accordingly, the user's body may be moved by the moving unit 330.

The moving unit controller 310 may generate movement data SUD and may provide the movement data SUD to the compensating device 200 (see FIG. 8). For example, the moving unit controller 310 may generate the movement data SUD indicating a distance the moving unit 330 has moved in the first direction DR1 (see FIG. 12) and/or the third direction DR3 (see FIG. 12). In embodiments, the movement data SUD may include information regarding a distance the moving unit 330 has moved from a first reference position RP1 (see FIG. 12) and from a second reference position RP2 (see FIG. 14).

The moving unit controller 310 may store the movement data SUD in the second memory 320. For example, the second memory 320 may store information regarding the first reference position RP1 and the second reference position RP2.

Referring to FIG. 11, an operating method of a system according to one or more embodiments of the present disclosure may include moving a user through the moving device (S1110), determining the user's viewing angle based on movement information of the moving unit (S1120), and obtaining a compensation parameter corresponding to the determined viewing angle from the memory, and generating compensation data based on the obtained compensation parameter (S1130).

Referring to FIG. 12, the moving unit 330 may include a first moving unit MU1 and a second moving unit MU2. The first moving unit MU1 may support at least a portion of the user's body of the display device 100. For example, the first moving unit MU1 may support the user's body in the first direction DR1 and the third direction DR3. The second moving unit MU2 may support at least a portion of the user's head of the display device 100. For example, the second moving unit MU2 may support the user's head in the first direction DR1.

In one or more embodiments, the first moving unit MU1 and the second moving unit MU2 may be driven independently. For example, the first moving unit MU1 may remain stationary while only the second moving unit MU2 moves. However, this is merely an example and not limited thereto.

In one or more embodiments, the moving unit 330 may be implemented in the form of a chair on which the user of the display device 100 can sit. However, this is merely an example, and the shape of the moving unit 330 is not limited as long as it is capable of moving a position of the user and the user's eyes UE.

The first reference position RP1 may be a relative reference point for representing the extent to which the first moving unit MU1 has moved. For example, the outermost edge of the unmoved first moving unit MU1 in the first direction DR1 and the third direction DR3 may correspond to the first reference position RP1. However, this is merely illustrative and not limited thereto.

The user of the display device 100 may be supported by the moving unit 330, and may view the image displayed by the display device 100. The user's eyes UE may be spaced apart from a central region CP of the display device 100 by a first horizontal distance VD1 in the first direction DR1. The user's eyes UE may also be spaced apart from the central region CP by a first vertical distance VH1 in the third direction DR3. Although “user's eyes” may be used in the plural herein, embodiments of the present application may be generally equally applicable to a single eye of a user.

The user may view the image displayed by the display device 100 with a first viewing angle VW1. For example, an angle formed between the user's eyes UE and the central region CP with reference to the first direction DR1 in FIG. 12 may be the first viewing angle VW1.

Referring to FIGS. 8 and 12, the viewing angle calculator 221 may calculate the first viewing angle VW1 based on the movement data SUD. For example, the movement data SUD may include information regarding a distance between the user's eyes UE and the central region CP according to preset values prior to the movement of the first moving unit MU1 and the second moving unit MU2. For example, the movement data SUD may include values for the first vertical distance VH1 and the first horizontal distance VD1.

The viewing angle calculator 221 may calculate a value of the first viewing angle VW1 according to Equation 1. In one or more embodiments, the viewing angle calculator 221 may generate viewing angle data VWD including the calculated value of the first viewing angle VW1.

$$VW 1 = arctan ( VH 1 / VD 1 ) \qquad Equation 1$$

In Equation 1, VW1 denotes the value of the first viewing angle VW1, VH1 denotes the first vertical distance VH1, and VD1 denotes the first horizontal distance VD1.

In one or more embodiments, the first viewing angle VW1 may be a reference viewing angle. For example, the first viewing angle VW1 may be a viewing angle when the user, supported by the first moving unit MU1 and second moving unit MU2 that are unmoved, views the image displayed by the display device 100.

Referring to FIGS. 11 and 13, in operation S1110, the moving unit controller 310 of FIG. 10 may move the first moving unit MU1 and the second moving unit MU2 from the first reference position RP1 to a 1a-th reference position RP1a. For example, the moving unit controller 310 may control the first moving unit MU1 to move by a first movement distance RD1 in a direction opposite to the first direction DR1. The user of the display device 100, supported by the first moving unit MU1, may be moved by the first movement distance RD1 in the opposite direction to the first direction DR1. The 1a-th reference position RP1a may be spaced by the first movement distance RD1 from the first reference position RP1 in the opposite direction to the first direction DR1.

After being moved by the first moving unit MU1, the user may view the image displayed by the display device 100. The user's eyes UE may be separated from the central region CP of the display device 100 by a second horizontal distance VD2 in the first direction DR1, and by the first vertical distance VH1 in the third direction DR3. The user of the display device 100 may view the image of the display device 100 with a second viewing angle VW2. For example, an angle formed between the user's eyes UE and the central region CP with reference to the first direction DR1 in FIG. 13 may be the second viewing angle VW2.

Referring to FIGS. 11 and 13, in operation S1120, the viewing angle calculator 221 of FIG. 8 may calculate the second viewing angle VW2 based on the movement data SUD. The movement data SUD may further include information regarding the first movement distance RD1 of the first moving unit MU1 from the first reference position RP1 in the first direction DR1.

The viewing angle calculator 221 may calculate a value of the second viewing angle VW2 according to Equation 2. In one or more embodiments, the viewing angle calculator 221 may generate viewing angle data VWD including the calculated value of the second viewing angle VW2.

$$VW 2 = arctan ( VH 1 / ( VD 1 + RD 1 ) ) \qquad Equation 2$$

In Equation 2, VW2 denotes the value of the second viewing angle VW2, VH1 denotes the first vertical distance VH1, VD1 denotes the first horizontal distance VD1, and RD1 denotes the first movement distance RD1.

Referring to Equation 2, the viewing angle calculator 221 may calculate the second viewing angle VW2 based on the distance that the user of the display device 100 has moved by the first movement distance RD1 by the first moving unit MU1. In a comparative example, a separate structure or device might be suitable to calculate the user's viewing angle. However, according to one or more embodiments of the present disclosure, the compensating device 200 (or the compensation data generator 220) may calculate the second viewing angle VW2 based on the first movement distance RD1 of the first moving unit MU1 from the first reference position RP1, without any separate structure or device.

Referring to FIGS. 11 and 14, in operation S1110, the moving unit controller 310 may move the moving unit 330 from the first reference position RP1 to a 1b-th reference position RP1b. For example, the moving unit controller 310 may control the first moving unit MU1 to move by a first movement distance RD1 in a direction opposite to the first direction DR1, and by a second movement distance RH1 in the third direction DR3. Accordingly, the user of the display device 100 may be moved by the first movement distance RD1 in the opposite direction to the first direction DR1 and by the second movement distance RH1 in the third direction DR3. The 1b-th reference position RP1b may be spaced apart from the first reference position RP1 by the first movement distance RD1 in the opposite direction to the first direction DR1 and by the second movement distance RH1 in the third direction DR3.

After being moved by the first moving unit MU1, the user may view the image displayed by the display device 100. The user's eyes UE may be separated from the central region CP by a second horizontal distance VD2 in the first direction DR1, and by a second vertical distance VH2 in the third direction DR3. The user of the display device 100 may view the image of the display device 100 with a third viewing angle VW3. For example, an angle formed between the user's eyes UE and the central region CP with reference to the first direction DR1 in FIG. 14 may be the third viewing angle VW3.

Referring to FIGS. 8, 11, and 14, in operation S1120, the viewing angle calculator 221 may calculate the third viewing angle VW3 based on the movement data SUD. The movement data SUD may further include information regarding the second movement distance RH1 that the first moving unit MU1 has moved from the first reference position RP1 in the third direction DR3.

The viewing angle calculator 221 may calculate the value of the third viewing angle VW3 according to Equation 3. In one or more embodiments, the viewing angle calculator 221 may generate viewing angle data VWD including the calculated value of the third viewing angle VW3.

$$VW 3 = arctan ( ( VH 1 + RH 1 ) / ( VD 1 + RD 1 ) ) \qquad Equation 3$$

In Equation 3, VW3 denotes the value of the third viewing angle VW3, VH1 denotes the first vertical distance VH1, VD1 denotes the first horizontal distance VD1, RD1 denotes the first movement distance RD1, and RH1 denotes the second movement distance RH1.

Referring to Equation 3, the viewing angle calculator 221 may calculate the third viewing angle VW3 based on a distance moved by the user of the display device 100 through the first moving unit MU1 and the second moving unit MU2 by the first movement distance RD1 and the second movement distance RH1. According to one or more embodiments of the present disclosure, the compensating device 200 (or the compensation data generator 220) may calculate the third viewing angle VW3 without any separate structure or device, based on the first movement distance RD1 and the second movement distance RH1 from the first reference position RP1.

A second reference position RP2 in FIG. 14 may be a relative reference point representing the extent of movement of the second moving unit MU2. For example, the outermost edge of the second moving unit MU2, which is unmoved in the first direction DR1 and the third direction DR3, may correspond to the second reference position RP2. However, this is merely illustrative and not limited thereto.

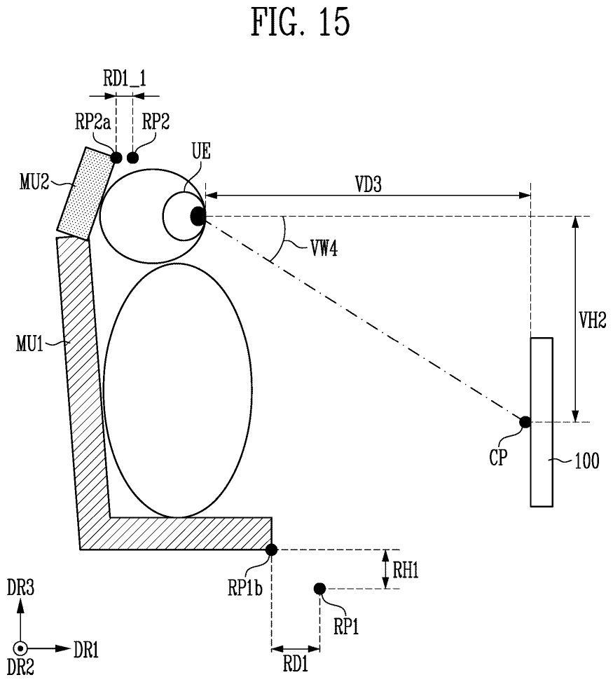

Referring to FIGS. 11 and 15, in operation S1110, the moving unit controller 310 may move the moving unit 330 from the second reference position RP2 to a 2a-th reference position RP2a. For example, the moving unit controller 310 may control the second moving unit MU2 to move by a 1_1st movement distance RD1_1 in a direction opposite to the first direction DR1. Accordingly, the user (or the user's head) of the display device 100 may be moved by the 1_1st movement distance RD1_1 in the opposite direction to the first direction DR1. The 2a-th reference position RP2a may be spaced apart from the second reference position RP2 by the 1_1st movement distance RD1_1 in the opposite direction to the first direction DR1.

After being moved by the second moving unit MU2, the user may view the image displayed by the display device 100. The user's eyes UE may be separated from the central region CP by a third horizontal distance VD3 in the first direction DR1 and by a second vertical distance VH2 in the third direction DR3. The user of the display device 100 may view the image with a fourth viewing angle VW4. For example, an angle formed between the user's eyes UE and the central region CP with reference to the first direction DR1 in FIG. 15 may be the fourth viewing angle VW4.

Referring to FIGS. 11 and 15, in operation S1120, the viewing angle calculator 221 of FIG. 8 may calculate the fourth viewing angle VW4 based on the movement data SUD. For example, the movement data SUD may further include information regarding the 1_1st movement distance RD1_1 that the second moving unit MU2 has moved from the second reference position RP2 in the opposite direction to the first direction DR1.

The viewing angle calculator 221 may calculate a value of the fourth viewing angle VW4 according to Equation 4. In one or more embodiments, the viewing angle calculator 221 may generate viewing angle data VWD including the calculated value of the fourth viewing angle VW4.

$$VW 3 = arctan ( ( VH 1 + RH 1 ) / ( VD 1 + RD 1 + RD1\_ 1 ) ) \qquad Equation 4$$

In Equation 4, VW4 denotes the value of the fourth viewing angle VW4, VH1 denotes the first vertical distance VH1, VD1 denotes the first horizontal distance VD1, RD1 denotes the first movement distance RD1, RH1 denotes the second movement distance RH1, and RD1_1 denotes the 1_1st movement distance RD1_1.

Referring to Equation 4, the viewing angle calculator 221 may calculate the fourth viewing angle VW4 based on the first movement distance RD1, the second movement distance RH1, and the 1_1st movement distance RD1_1 moved by the user through the first moving unit MU1 and the second moving unit MU2. According to one or more embodiments of the present disclosure, the compensating device 200 (or the compensation data generator 220) may calculate the fourth viewing angle VW4 without any separate structure or device, based on the first movement distance RD1 and the second movement distance RH2 that the first moving unit MU1 moves from the first reference position RP1 and the 1_1st movement distance RD1_1 that the second moving unit MU2 moves from the second reference position RP2.

In one or more embodiments, when only the second moving unit MU2, which supports a portion of the user's head, is moved, the viewing angle calculator 221 may calculate the user's viewing angle based solely on the 1_1st movement distance RD1_1 of the second moving unit MU2.

Referring again to FIGS. 9 and 11, in operation S1130, after calculating the viewing angle, the viewing angle calculator 221 may determine an output compensation parameter corresponding to the calculated viewing angle among the compensation parameters CPD stored in the first memory 210. For example, the parameter determiner 222 may determine an observation angle AG corresponding to the calculated viewing angle included in the viewing angle data VWD. Then, the parameter determiner 222 may determine the output compensation parameter corresponding to the identified observation angle AG among the compensation parameters CPD. The parameter determiner 222 may read the output compensation parameter from the first memory 210.

In one or more embodiments, the compensation data generator 220 may perform interpolation based on compensation parameter values stored in the first memory 210 to determine the output compensation parameter corresponding to the calculated viewing angle. For example, the calculated viewing angle may fall between the first observation angle AG1 (see FIG. 9) and the second observation angle AG2 (see FIG. 9) stored in the first memory 210. The parameter determiner 222 may generate a new compensation parameter based on the first compensation parameter CPD1 (see FIG. 9) corresponding to AG1 and the second compensation parameter CPD2 (see FIG. 9) corresponding to AG2. The new compensation parameter may be provided as the output compensation parameter.

Thereafter, the parameter determiner 222 may generate compensation data CD based on the output compensation parameter that was read.

According to one or more embodiments of the present disclosure, the compensating device 200 may compensate the image to correspond to each of the viewing angles of the image displayed by the display device 100. For example, the compensating device 200 may store compensation parameters CPD1 to CPDk+1 (see FIG. 9) corresponding to a plurality of observation angles AG0 to AGk (see FIG. 9). The compensating device 200 may determine a viewer's viewing angle, and may provide the compensation parameter, which corresponds to the determined viewing angle among the compensation parameters CPD1 to CPDk+1, as the output compensation parameter. The compensating device 200 may generate compensation data CD based on the output compensation parameter. Accordingly, the risk of color deflection phenomenon occurring depending on the viewing angle of the image of the display device 100 may be relatively reduced. Therefore, regardless of where the user of the display device 100 views the image, the display system 1000 (see FIG. 1) may output an image with improved visibility.

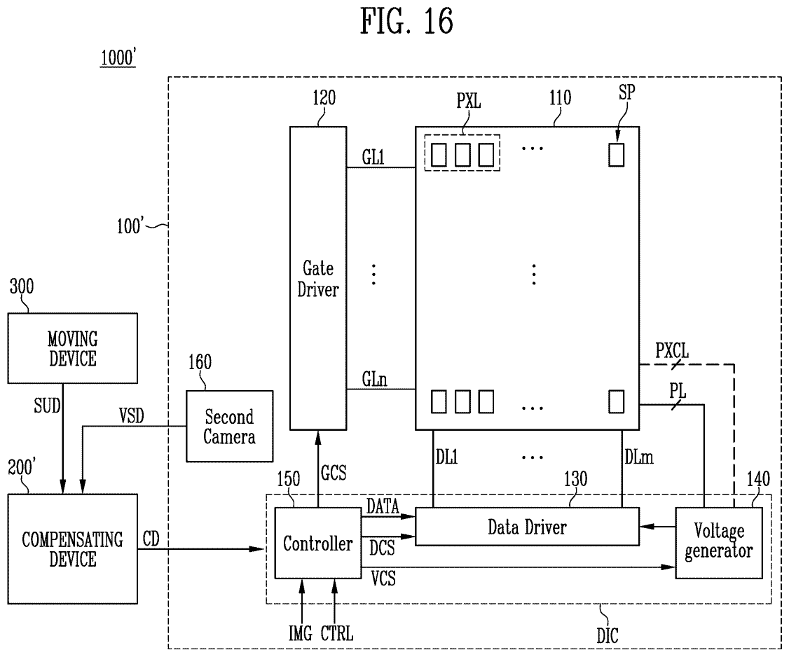

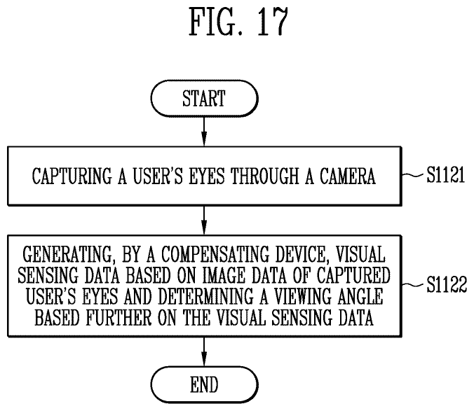

FIG. 16 is a block diagram illustrating one or more embodiments of the display system. FIG. 17 is a flowchart illustrating one or more embodiments of operation S1120 of FIG. 11.

Referring to FIG. 16, the display system 1000′ may include a display device 100′, a compensating device 200′, and a moving device 300. The moving device 300 of FIG. 16 may be described similarly to the moving device 300 of FIG. 1. Hereinafter, redundant descriptions will be omitted.

The display device 100′ may include a display panel 110, a gate driver 120, a data driver 130, a voltage generator 140, a controller 150, and a second camera 160. The display panel 110, the gate driver 120, the data driver 130, the voltage generator 140, and the controller 150 of FIG. 16 may be described similarly to the display panel 110, the gate driver 120, the data driver 130, the voltage generator 140, and the controller 150 of FIG. 1.

The second camera 160 may include an image sensor. In one or more embodiments, the second camera 160 may be a CCD camera. However, this is merely an example and not limited thereto.

Referring to FIG. 17, operation S1120 may include capturing (S1121) the user's eyes through the camera, and generating (S1122), by the compensating device, visual sensing data based on the image data of the captured user's eyes and determining the viewing angle based further on the visual sensing data.

Referring to FIGS. 16 and 17, in operation S1121, the second camera 160 may capture a user who is viewing an image displayed by the display device 100′. For example, the second camera 160 may capture the eyes UE (see FIG. 11) of the user viewing the image displayed by the display device 100′.

In operation S1122, the second camera 160 may generate visual sensing data VSD based on the image data capturing the user's eyes UE. The visual sensing data VSD may include information regarding the user's gaze and viewing range corresponding to the eyes UE.

In operation S1122, the compensating device 200′ may generate visual sensing data VSD based on the image data capturing the user's eyes UE (see FIG. 12), and may determine the viewing angle based further on the generated visual sensing data VSD. For example, the compensating device 200′ of FIG. 16 may calculate the user's viewing angle based on movement data SUD in the same manner as the compensating device 200 of FIG. 1. Then, the compensating device 200′ may secondarily calculate an evaluation viewing angle based on the visual sensing data VSD. In one or more embodiments, the compensating device 200′ may verify whether the calculated user's viewing angle and the evaluation viewing angle are the same. If the calculated user's viewing angle and the evaluation viewing angle are not identical, the compensating device 200′ may recalculate the user's viewing angle based on the movement data SUD using the methods described with reference to FIGS. 11 to 15.

In one or more embodiments, the compensating device 200′ may determine the user's viewing angle by reflecting preset weights assigned to the calculated viewing angle and the evaluation viewing angle based on the movement data SUD. For example, the compensating device 200′ may determine the user's viewing angle by using the sum of half of the calculated viewing angle and half of the evaluation viewing angle. However, this is merely an example and is not limited thereto.

Except for additionally determining the user's viewing angle based on the visual sensing data VSD, the compensating device 200′ of FIG. 16 may operate in the same manner as the compensating device 200 of FIG. 1. Redundant descriptions are omitted.

According to one or more embodiments of the present disclosure, the compensating device 200′ may determine the viewing angle based on both the movement data SUD and the visual sensing data VSD, thereby enhancing the reliability of the determined viewing angle. Accordingly, the image of the display device 100 may be compensated based on the more reliable viewing angle, improving the quality of the image provided to the user.

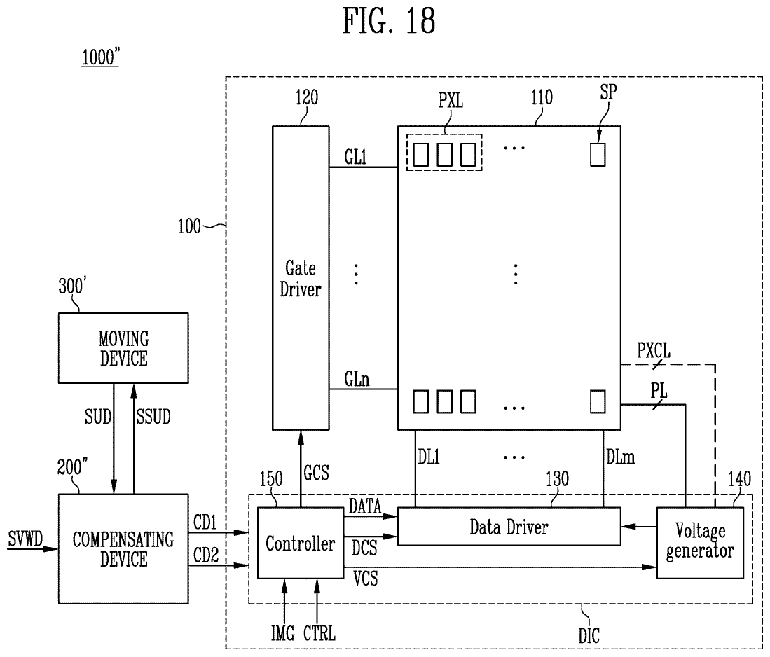

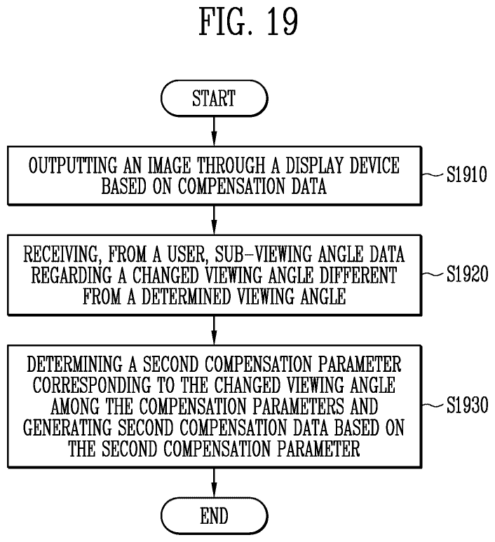

FIG. 18 is a block diagram illustrating one or more embodiments of the display system. FIG. 19 is a flowchart illustrating a compensation method for the display device according to one or more embodiments of the present disclosure.

Referring to FIG. 18, the display system 1000″ may include a display device 100, a compensating device 200″, and a moving device 300′. The display device 100 of FIG. 18 may be described similarly to the display device 100 of FIG. 1. Redundant descriptions will be omitted. Additionally, the configurations and operations of the compensating device 200″ and the moving device 300′ of FIG. 18 may be described similarly to the compensating device 200 and the moving device 300 of FIG. 1. Hereinafter, for the sake of convenience, the redundant descriptions will be omitted, and only the differences will be described.

Referring to FIGS. 18 and 19, a compensation method for a display device according to one or more embodiments of the present disclosure may include outputting an image through the display device based on compensation data (S1910), receiving, from the user, sub-viewing angle data regarding a changed viewing angle that is different from the determined viewing angle (S1920), and determining a second compensation parameter corresponding to the changed viewing angle among the compensation parameters and generating second compensation data based on the second compensation parameter (S1930).

In operation S1910, the display device 100 may output an image based on first compensation data CD1. For example, the compensating device 200″ may generate the first compensation data CD1 based on movement data SUD.

The first compensation data CD1 may be data for primarily compensating the image displayed by the display device 100 through the compensating device 200″. In one or more embodiments, the first compensation data CD1 may be the same as the compensation data CD of FIG. 1. For example, the method for generating the first compensation data CD1 may be identical to the method for generating the compensation data CD of FIG. 1.

In operation S1920, the compensating device 200″ may receive sub-viewing angle data SVWD regarding a changed viewing angle that is different from the determined viewing angle from the user. For example, after operation S1910, the user may view the image output based on the first compensation data CD1 and may input the sub-viewing angle data SVWD to the compensating device 200″ after viewing the image. For example, the image output based on the first compensation data CD1 may be an image compensated for a user viewing from the first viewing angle VW1 (see FIG. 12). In this case, for the user of the display device 100, the visibility of the image compensated for the second viewing angle VW2 (see FIG. 13) may be the highest. Accordingly, the user may view the image output based on the first compensation data CD1, may set the second viewing angle VW2 as the changed viewing angle, and may input the sub-viewing angle data SVWD including information regarding the changed viewing angle into the compensating device 200″. However, this is merely an example and not limited thereto.

In one or more embodiments, the image output based on the first compensation data CD1 may include a grid pattern. Accordingly, it may be relatively easier for the user to view the image output based on the first compensation data CD1 and to set the changed viewing angle. However, this is merely an example and not limited thereto.

In operation S1930, the compensating device 200″ may determine, based on the sub-viewing angle data SVWD, a second compensation parameter corresponding to the changed viewing angle among the compensation parameters CPD (see FIG. 9). For example, the compensating device 200″ may determine an observation angle AG (see FIG. 9) corresponding to the changed viewing angle. The compensating device 200″ may determine the second compensation parameter corresponding to the determined observation angle AG among the compensation parameters CPD (see FIG. 9).

The compensating device 200″ may read the second compensation parameter from the memory of the compensating device 200″. In one or more embodiments, the memory of the compensating device 200″ may be the same as the first memory 210 shown in FIG. 8.

In operation S1930, the compensating device 200″ may generate second compensation data CD2 based on the determined second compensation parameter. The second compensation data CD2 may be data for secondarily compensating the image displayed by the display device 100 through the compensating device 200″.

The compensating device 200″ may provide the second compensation data CD2 to the display device 100. The display device 100 may output an image based on the second compensation data CD2. For example, the display device 100 may secondarily correct the input image data IMG based on the second compensation data CD2 and may output image data DATA based on the corrected image data.

According to one or more embodiments of the present disclosure, the display system 1000″ may secondarily compensate the image displayed by the display device 100 based on the second compensation data CD2 and provide an image with relatively improved quality to the user.

The compensating device 200″ may provide sub-movement data SSUD to the moving device 300′. The sub-movement data SSUD may indicate the position of the moving unit 330 (see FIG. 10) corresponding to the changed viewing angle. For example, the compensating device 200″ may calculate the position of the moving unit 330 based on the changed viewing angle, and may provide the sub-movement data SSUD representing the calculated position to the moving device 300′. For example, the compensating device 200″ may calculate the position of the moving unit 330 based on the changed viewing angle and the current horizontal distance. Alternatively, the compensating device 200″ may calculate the position based on the changed viewing angle and the current vertical distance. However, embodiments are not limited thereto.

The moving device 300′ may store the sub-movement data SSUD in a storage medium. For example, the moving device 300′ may store the sub-movement data SSUD in the second memory 320 (see FIG. 10).

In one or more embodiments, in operation S1930, the moving device 300′ may store the sub-movement data SSUD in the second memory 320. However, this is merely an example and not limited thereto.

In one or more embodiments, the moving device 300′ may move the moving unit 330 based on the stored sub-movement data SSUD. For example, when the user uses the display system 1000″ at a later time, the moving device 300′ may move the moving unit 330 based on the sub-movement data SSUD. In other words, the moving unit 330 may be moved to a position corresponding to the changed viewing angle. Accordingly, the user may utilize the display system 1000″ from a position of the moving unit 330 set to correspond to the changed viewing angle. According to one or more embodiments of the present disclosure, the user of the display system 1000″ may view the image displayed by the display device 100 from a preset viewing angle (e.g., the changed viewing angle) without any additional operations.

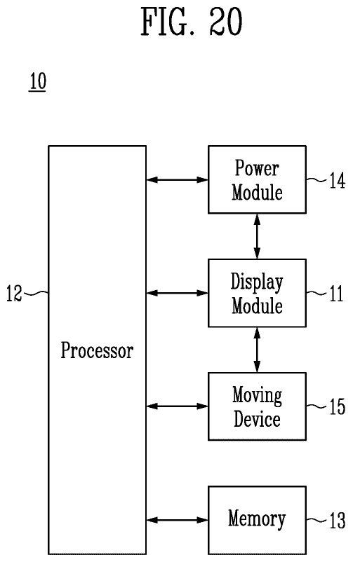

FIG. 20 is a block diagram illustrating an electronic device according to one or more embodiments. Referring to FIG. 20, an electronic device 10 according to one or more embodiments may include a display module 11, a processor 12, a memory 13, a power module 14, and a moving device 15. The display module 11 of FIG. 20 may be described similarly to the display device 100 of FIG. 1.

FIG. 20 is a block diagram illustrating an electronic device according to one or more embodiments. Referring to FIG. 20, an electronic device 10 according to one or more embodiments may include a display module 11, a processor 12, a memory 13, a power module 14, and a moving device 15. The display module 11 of FIG. 20 may be described similarly to the display device 100 of FIG. 1.

The processor 12 may include at least one of a central processing unit (CPU), an application processor (AP), a graphic processing unit (GPU), a communication processor (CP), an image signal processor (ISP), or a controller. The processor 12 may function as the compensating device 200 of FIG. 1. For example, the processor 12 and/or the memory 13 may store firmware and/or software configured to perform the functions of the compensation data generator 220 of FIG. 8 when executed by the processor 12. By executing such firmware and/or software, the processor 12 may perform the functions of the compensation data generator 220 of FIG. 8.

The memory 13 may store data and information suitable for the operations of the processor 12 or the display module 11. When the processor 12 executes an application stored in the memory 13, image data signals and/or input control signals may be transmitted to the display module 11, and the display module 11 may process the received signals and may output image information through a display screen.

The power module 14 may include a power supply module, such as a power adapter or a battery device, and a power conversion module configured to convert the supplied power into power suitable for operating the electronic device 10.

The moving device 15 may include a moving unit for moving the user of the electronic device 10. The moving device 15 of FIG. 20 may be described similarly to the moving device 300 of FIG. 1. Redundant descriptions are omitted.

At least one of the components of the electronic device 10 described above may be included within the display device according to the embodiments described above. In addition, among the individual modules functionally included within a single module, some may be included in the display device, while others may be provided separately from the display device. For example, the display device may include the display module 11, whereas the processor 12, the memory 13, the power module 14, and the moving device 15 may be provided in the form of another device within the electronic device 10 other than the display device.

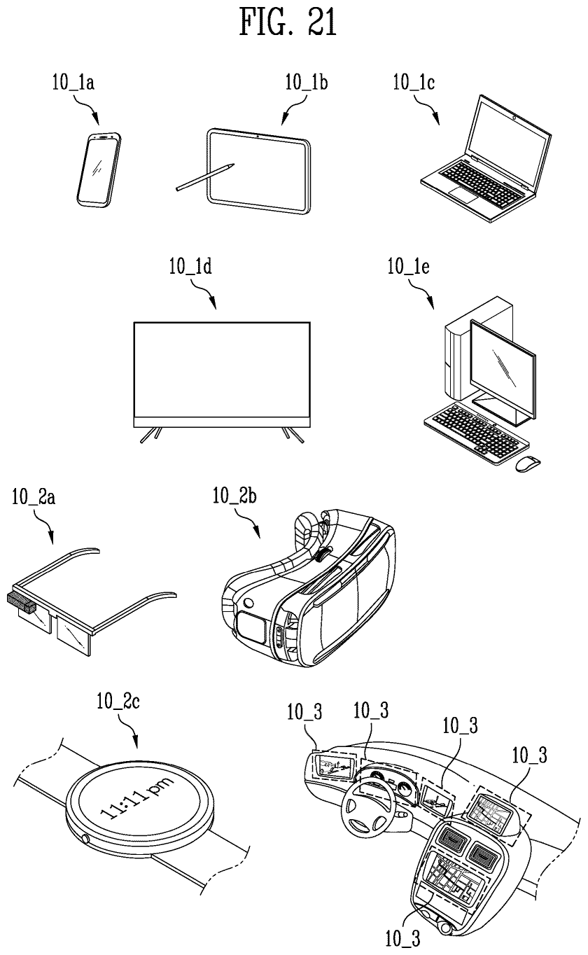

FIG. 21 illustrates schematic diagrams of electronic devices according to various embodiments.

Referring to FIG. 21, various electronic devices to which the display device according to the embodiments is applied may include image display electronic devices, such as a smartphone 10_1a, a tablet PC 10_1b, a laptop 10_1c, a TV 10_1d, and a desktop monitor 10_1e, as well as wearable electronic devices including a display module, such as smart glasses 10_2a, a head-mounted display 10_2b, and a smart watch 10_2c, and automotive electronic devices 10_3 that incorporate display modules 11, such as a vehicle's instrument cluster, a center fascia, a CID (Center Information Display) mounted on a dashboard, or a room mirror display, and the like. In one or more embodiments, the display device 100 (see FIG. 1) may be implemented as the vehicle's instrument panel, the center fascia, the CID (Center Information Display) placed on a dashboard, or the room mirror display.

Although embodiments and applications have been described herein, other embodiments and modifications may be derived from the above disclosure. Accordingly, the spirit of the present disclosure is not limited to the disclosed embodiments, but extends to the appended claims, various obvious modifications, and equivalents.

What is claimed is:

1. A method for operating a display system, the method comprising:
moving a user using a moving device comprising a moving unit configured to support the user;
determining a viewing angle of the user based on movement information of the moving unit;
obtaining one of compensation parameters corresponding to the viewing angle from a memory of the display system; and
generating compensation data for a display device based on the one of the compensation parameters.

2. The method of claim 1, wherein the movement information indicates a distance of the moving unit from a reference position,
wherein the reference position is a first distance from a center point of the display device in a first direction, and is a second distance from the center point in a second direction that is different from the first direction, and
wherein the viewing angle is based on a ratio of the second distance to the first distance when the moving unit corresponds to the reference position.

3. The method of claim 2, wherein the viewing angle is based on a ratio of the second distance to a sum of the first distance and a first movement distance by which the moving device moves the user from the reference position in the first direction.

4. The method of claim 3, wherein the viewing angle is based on a ratio of a sum of the second distance and a second movement distance to the sum of the first distance and the first movement distance when the moving device moves the user from the reference position by the second movement distance in the second direction.

5. The method of claim 4, wherein the moving unit comprises a first moving unit and a second moving unit that are configured to be independently driven, and
wherein, when the first moving unit is configured to move the user from the reference position by the first movement distance and the second movement distance, and when the second moving unit is configured to move the user by a 1_1st movement distance in the first direction from the reference position, the viewing angle is based on a ratio of the sum of the second distance and the second movement distance to a sum of the first distance, the first movement distance, and the 1_1st movement distance.

6. The method of claim 1, wherein the determining the viewing angle comprises:
capturing an image of an eye of the user;
generating visual sensing data based on the image; and
determining the viewing angle based on the visual sensing data.

7. The method of claim 1, further comprising:
outputting an image through the display device based on the compensation data;
receiving sub-viewing angle data regarding a changed viewing angle that is different from the viewing angle;
determining a second one of the compensation parameters corresponding to the changed viewing angle; and
generating second compensation data based on the second one of the compensation parameters.

8. The method of claim 7, wherein the generating the second compensation data comprises storing a position of the moving unit corresponding to the changed viewing angle in a storage medium of the moving device.

9. A display system comprising:
a display device for outputting an image based on compensation data;
a moving device comprising a moving unit configured to support a user of the display device and to move the user; and
a compensating device configured to provide the compensation data to the display device, and comprising:
a memory configured to store compensation parameters respectively corresponding to viewing angles; and
a compensation data generator configured to determine a viewing angle of the user based on movement information of the moving unit, to obtain one of the compensation parameters corresponding to the viewing angle from the memory, and to generate the compensation data based on the one of the compensation parameters.

10. The display system of claim 9, wherein the movement information indicates a distance of the moving unit from a reference position that is a first distance from a center point of the display device in a first direction, and that is a second distance from the center point in a second direction different from the first direction, and
wherein the compensation data generator is configured to calculate the viewing angle based on a ratio of the second distance to the first distance.

11. The display system of claim 10, wherein, when the moving device moves the user from the reference position in the first direction by a first movement distance, the compensation data generator is configured to calculate the viewing angle based on a ratio of the second distance to a sum of the first distance and the first movement distance.

12. The display system of claim 11, wherein, when the moving device moves the user from the reference position in the second direction by a second movement distance, the compensation data generator is configured to calculate the viewing angle based on a ratio of a sum of the second distance and the second movement distance to the sum of the first distance and the first movement distance.

13. The display system of claim 12, wherein the moving unit comprises a first moving unit and a second moving unit, which are configured to be independently driven, and
wherein, when the first moving unit moves the user from the reference position by the first movement distance and the second movement distance, and the second moving unit moves the user by a 1_1st movement distance in the first direction from the reference position, the compensation data generator is configured to calculate the viewing angle based on a ratio of the sum of the second distance and the second movement distance to a sum of the first distance, the first movement distance, and the 1_1st movement distance.

14. The display system of claim 9, wherein the display device comprises a camera configured to capture an image of an eye of the user, and
wherein the compensating device is configured to generate visual sensing data based on the image, and to determine the viewing angle based on the visual sensing data.

15. The display system of claim 9, wherein the display device is implemented as a vehicle display device.

16. An electronic device comprising:
a processor;
a display device configured to display an image according to a control of the processor; and
a moving device comprising a moving unit configured to support a user of the display device and to move the user,
wherein the processor:
comprises a memory configured to store compensation parameters respectively corresponding to viewing angles;
is configured to determine a viewing angle of the user based on movement information of the moving unit;
is configured to obtain one of the compensation parameters corresponding to the viewing angle from the memory;
is configured to generate compensation data based on the one of the compensation parameters; and
is configured to provide the generated compensation data to the display device.

17. The electronic device of claim 16, wherein the movement information indicates a distance of the moving unit from a reference position,
wherein the reference position is a first distance from a center point of the display device in a first direction, and is a second distance from the center point in a second direction that is different from the first direction, and
wherein the viewing angle is based on a ratio of the second distance to the first distance when the moving unit corresponds to the reference position.

18. The electronic device of claim 17, wherein the viewing angle is based on a ratio of the second distance to a sum of the first distance and a first movement distance by which the moving device moves the user from the reference position in the first direction.

19. The electronic device of claim 16, wherein the processor is configured to determine the viewing angle by:
capturing an image of an eye of the user;
generating visual sensing data based on the image; and
determining the viewing angle based on the visual sensing data.

20. The electronic device of claim 16, wherein the processor is further configured to:
output the image through the display device based on the compensation data;
receive sub-viewing angle data regarding a changed viewing angle that is different from the viewing angle;
determine a second one of the compensation parameters corresponding to the changed viewing angle; and
generate second compensation data based on the second one of the compensation parameters.
